(19) United States
(12) Patent Application Publication
(10) Pub. No.: US 2009/0089080 A1
(43) Pub. Date: Apr. 2, 2009

(54) DYNAMIC STAFFING CONTROL NOTIFICATION METHOD

(76) Inventor: Michael Meisel, Oak Park, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/862,419

(22) Filed: Sep. 27, 2007

(51) Int. Cl. G06Q 50/00

(52) U.S. Cl. 705/2

(57) ABSTRACT

A process for dynamically controlling the scheduled staff in a department of a medical care facility wherein an initial workload requirement and staffing level requirement are calculated based upon either required patient care or scheduled medical procedures. Staff is scheduled to meet this calculated staffing level requirement. At some later time an updated workload requirement and updated staffing level requirement are calculated based upon changes in required patient care or scheduled medical procedures. The updated requirements are compared to the scheduled medical staff. Management is notified of a variance between the updated workload requirement and the assigned medical staff that exceeds a predefined threshold.

### BACKGROUND OF THE INVENTION

The present invention relates generally to a method for dynamically controlling the work schedule of staff in a medical care facility and more particularly, to a method employed in a software module for assigning medical staff sufficient to meet an initial workload requirement, determining at a later time whether the assigned medical staff is within tolerances for an updated workload requirement, and notifying management staff if the assigned staff is not within the tolerances for the updated workload requirement.

Hospitals and other health care facilities have recently been experiencing recurring problems in maintaining appropriate staffing levels to meet periods of high or low demand. These problems are experienced in hospitals, urgent care facilities, doctors' offices and other treatment facilities where the number of patients treated may fluctuate throughout a day and lesser or greater staffing may be required.

One particular problem in such facilities is that supply and demand fluctuates from hour to hour. Where a facility contains multiple independent departments, such supply and demand is spread unevenly among the different departments, often due at least originally to causes beyond the control of the management of the facility. If each department of a facility is properly staffed only for average or start of shift conditions, periods of unusually high or low demand cannot be readily accommodated. This requires the department staff to work harder to meet the increased demand, which can result in burnout or resignations, or be idle, which can result in tedium or inattentiveness, thus aggravating the problem. Burnout or resignations of existing medical staff requires that replacement medical staff be trained.

Another problem in medical facilities with multiple departments is that one department sometimes does not communicate in an adequate and timely manner with another department of the same facility. If the management of a facility or department within a facility receives sufficient notice of an increased or decreased demand in medical staff or resources, the management has an opportunity to change medical staff to meet the changed demand. For example, if a hospital emergency room suddenly has an influx of patients due to events outside the control of management, this influx may create a strain on the currently assigned medical staff, resulting in that staff becoming overworked. The sooner management staff is notified of the increased demand, the sooner management can call in additional medical staff.

Given current technology today, there are a number of ways that can increase the speed with which management is notified of a changed workload. These notification means can get a message to management very quickly that scheduled staff needs to be changed. One of the causes for a delay in such notification is that the need to change medical staff is not readily apparent.

There is currently software available to automate facility wide staffing and scheduling and formulate schedules with clinically sound, skill matched, financially optimized and productive staffing. Such software enables a user to pinpoint both cost and labor hour leaks and identify specific units or departments that have ongoing productivity problems due to understaffing or overstaffing, excessive overtime hours or inordinate use of outside facility staff. The software allows a user to uncover the underlying causes of such issues and provides choices to better maintain appropriate staffing and cost controls.

However, such software does not allow adjustment of the staffing levels in real time. Such real time adjustment would become necessary when a facility or department receives unforeseen admissions or transfers and suddenly the assigned staff is inadequate or unforeseen discharges or transfers resulting in excessive staff. Previous staffing decisions may not be in compliance with facility policies, regulatory standards, and state mandated staffing ratios. Currently assigned medical staff makes due as best they can, typically until the next shift starts and then only if scheduled staff can be changed.

Therefore, there is a need to anticipate staffing problems and make adjustments to assigned staff in real time. In addition, there is a need to quickly and efficiently communicate these anticipated staffing problems to management and permit management the ability to adjust assigned staff in real time. The present invention fulfills these needs and provides other related advantages.

### SUMMARY OF THE INVENTION

A software module that accesses a facility's patient ADT (admission, discharge, transfer) system and processes patient admissions, discharges and transfers in real time is the first step in meeting these needs. Such a module preferably performs an initial evaluation of the patients in a facility or department. Preferably, this module would conduct a re-evaluation of the patients in a facility or department a number of times during the shift. The initial evaluation and subsequent reevaluations would take into account patient acuity and other staffing effectiveness indicators allowing the module to automatically determine up-to-the-minute workloads for each facility or department.

A separate software module then runs the revised unit workloads through simulation routines and calculates updated recommended staffing requirements and levels. The inventive module then compares the updated recommended staffing requirements and levels to the current staffing levels. When the variance between the recommended levels and the current levels fall outside of preset thresholds, management is automatically notified via electronic means of the variance.

The present invention is directed to a process for dynamic staffing control in a medical care facility which is accomplished automatically by a software module which is part of a comprehensive software system. The module begins by calculating an initial workload requirement for the facility. The module next determines a staffing level requirement based upon the initial workload requirement and schedules medical staff in the facility to meet the staffing level requirement. This initial calculation, determination and scheduling is typically performed at the start of a shift, however, the module can also “look ahead” to future shifts and perform the initial calculation for any number of future shifts in a user-defined “look ahead” period.

At some later point in a shift, preferably at user-defined intervals, the module estimates an updated workload requirement for the facility and then determines an updated staffing level requirement based thereupon. Next the updated staffing level requirement is compared to the scheduled medical staff. If this updated staffing level requirement varies from the currently scheduled medical staff by more than a predetermined threshold, then a notification alert is sent.

The overall process may be applied facility-wide or to an individual department within the facility. Further, the initial workload requirement, the staffing level requirement and the scheduled medical staff may be based upon the number of patients in a facility and the care required for each of those patients. Similarly, the updated workload requirement and updated staffing level requirement may be based upon the number of patients admitted, discharged and/or transferred into or out of a facility. Alternatively, the initial workload requirement, staffing level requirement and scheduled medical staff may be based upon scheduled medical procedures and resources required for each of those procedures. Further, the updated workload requirement and updated staffing level requirement may be based upon canceled, rescheduled or newly scheduled medical procedures and the resources required therefor.

Where the initial workload requirement is based upon patients and the care required, the module will generate a list of patients in the facility or department, each patient having assigned patient care attributes. A patient workload is calculated for each patient by summing workload values corresponding to the assigned patient care attributes. The initial workload requirement is calculated by summing the patient workload for each patient in the facility.

Determining the staffing level requirement involves evaluating required staff hours per patient based upon direct care skill level for the assigned patient care attributes and an acuity level for each patient. Assigning direct care medical staff to each patient is based upon a patient acuity level, direct care skill levels, prior staff assignments and required staff hours.

An updated workload requirement is estimated by generating a list of patients discharged or transferred out of the facility and new patients admitted or transferred into the facility since calculating the initial workload requirement. A workload reduction is calculated for the patients discharged or transferred out of the facility and a workload increase is calculated for the new patients admitted or transferred into the facility. The updated workload requirement is estimated by subtracting the workload reduction from the initial workload requirement and adding the workload increase to the initial workload requirement. The workload increase is calculated by multiplying the number of new patients admitted and transferred into the facility by a user-defined standard patient workload for the facility or department. The workload reduction is calculated based upon a sum of the previously calculated patient workload for each patient discharged or transferred out of the facility.

Where the workload is based upon scheduled medical procedures, the initial workload requirement is calculated by generating a list of medical procedures to be performed and summing up the resource workload for the required resources for each procedure. A resource workload is calculated for each medical procedure by summing workload values corresponding to the required resources for each medical procedure. Finally, the initial workload requirement is calculated by summing the resource workload for each medical procedure.

Determining the staffing level requirement involves determining the required staff hours per medical procedure and summing the required staff hours by skill level or job role in the procedure. Medical staff sufficient to meet the required staff hours is scheduled for each procedure based upon skill level or job role.

An updated workload requirement is calculated by generating a list of canceled, rescheduled or newly scheduled medical procedures scheduled since the initial workload requirement was calculated. A workload reduction is calculated for the canceled or rescheduled out of shift medical procedures and a workload increase is calculated for the rescheduled in shift or new medical procedures. The updated workload requirement is calculated by subtracting the workload reduction from the initial workload requirement and adding the workload increase to the initial workload requirement. The workload increase is calculated by summing the workload requirement for each new or rescheduled in shift medical procedure. The workload reduction is calculated based upon a sum of the previously calculated resource workloads for each canceled or rescheduled out of shift medical procedure.

Regardless of the basis for the workload calculation, the step of sending a notification alert if the updated staffing level requirement varies from the assigned medical staff by more than a predetermined threshold involves determining a notification cause based upon a reason for the updated staffing level requirement. The module then determines which staff are to be notified based upon the notification cause and prepares a notification alert based upon user-defined notification preferences. The appropriate staff are then notified by alert means based upon employee communication preferences.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flowchart illustrating a patient admission, discharge, and unit transfer interface for a medical facility;

FIG. 2 is a flowchart illustrating a patient classification process according to the present invention;

FIG. 3 is a flowchart illustrating a patient workload threshold and staffing variance tolerance check according to the present invention;

FIG. 4 is a flowchart illustrating a surgery workload threshold and staffing variance tolerance check according to the present invention.

FIG. 5 is a flowchart illustrating a patient staff assignment process according to the present invention;

FIG. 6 is a flowchart illustrating a department workload calculation according to the present invention;

FIG. 7 is a flowchart illustrating the notification alert process according to the present invention; and

### DETAILED DESCRIPTION OF THE PREFERRED EMBODIMENTS

As shown in the figures for purposes of illustration, the present invention is concerned with a process for dynamically controlling the scheduling and assignment of staff in a medical care facility. In a preferred embodiment, the inventive process is practiced through the use of a software program with various subroutines. However, a user may practice the process steps described herein manually and still achieve the same result.

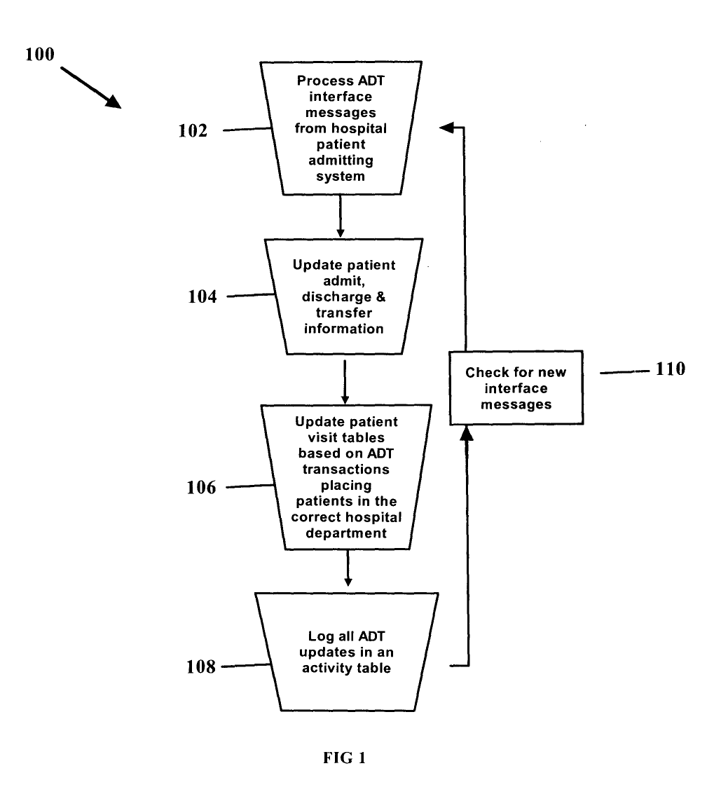

The process subroutines include patient admission, discharge and unit transfer processing; patient classification processing; patient workload threshold and staffing variance tolerance checks processing; surgery workload threshold and staffing variance tolerance checks; department workload calculation processing; patient staff assignment processing; and staff notification processing among others. Flowcharts of each of these processes and/or subroutines are illustrated and generally referred to in FIGS. 1-7.

The following detailed description generally describes the application of the below processes to a department within a medical facility, however, the processes apply equally as well to the entire medical facility or other discrete units. The terms for each may be used interchangeably. A person having ordinary skill in the art will realize that the application of this process to any of the above-described levels will not change the scope of the invention. In addition, this process will be described as if being applied to the current shift or the current shift being scheduled, i.e., the next shift. However, the process may apply equally as well to any number of future shifts that fall within a user-defined scheduling period, i.e., all shifts for the following week.

FIG. 1 illustrates a flowchart for processing patient admission, discharge, and unit transfer (ADT) for a department in a medical care facility (100). The initial step in this routine involves processing ADT interface messages from a facility patient admitting system (102). This processing step (102) involves reviewing and acting upon ADT interface messages. ADT interface messages typically involve orders of admission, discharge and/or transfer. The next step involves updating patient admit, discharge and transfer information (104). This updating step (104) involves changing an individual patient's record to reflect an admit, discharge or transfer order. The next step, updating patient visit tables based on ADT transactions (106), involves correcting department records to properly reflect which patients have been admitted into a particular department, or are in the process of transferring to another department. The final step in the ADT process (100) requires the logging of all ADT updates in an activity table (108). The step of logging ADT updates (108) provides a quick reference for a user or another subroutine to locate ADT information since a particular point in time, i.e., the start of shift. This processing of patient ADT information (100) is initiated again by the step of checking for new interface messages (110).

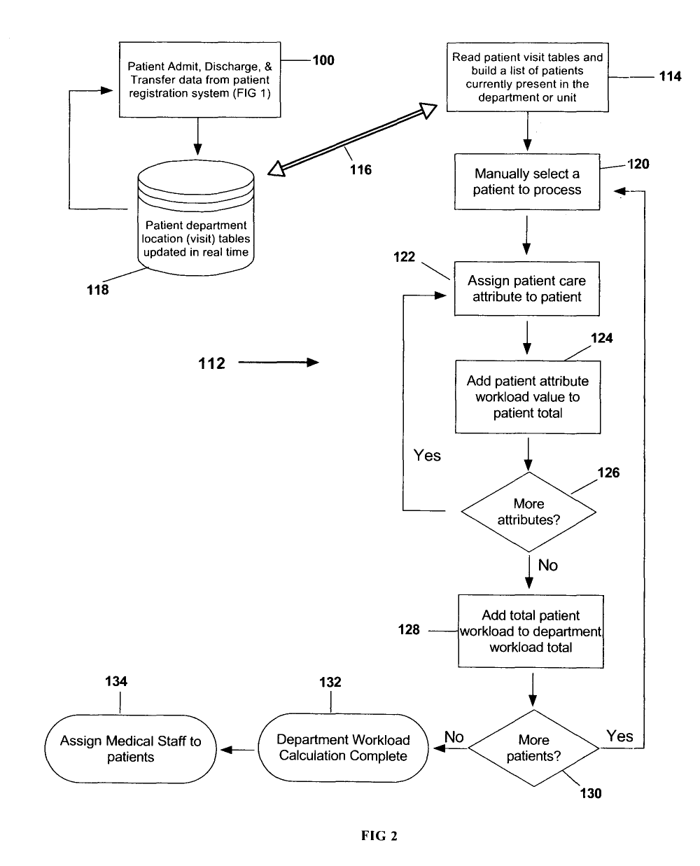

FIG. 2 illustrates a patient classification process (112) where each patient in a department is assigned attributes and workload values to determine that patient's effect on a department workload. This classification process (112) begins with the step of reading patient visit tables and building a list of patients currently present in the department (114). The step of reading patient visit tables (114) relies upon access (116) to a database (118) containing patient department location (visit) tables updated in real time. This database (118) is populated with information generated by the patient ADT process (100) described in FIG. 1. The next step in the classification process (112) involves manually selecting a patient to process (120).

This patient is next assigned patient care attributes (122). The patient care attributes correspond to care that a particular patient needs while under the care of the department. Each patient care attribute, i.e., medications, routine checks, replacing IV solution, etc., are assigned a workload value. This workload value is added to a patient total (124). The routine then checks if there are more patient care attributes to be assigned (126). If there are more patient care attributes to be assigned, the steps of assigning patient care attribute to patient (122) and adding patient attribute workload value to patient total (124) are repeated until there are no more patient care attributes for that patient.

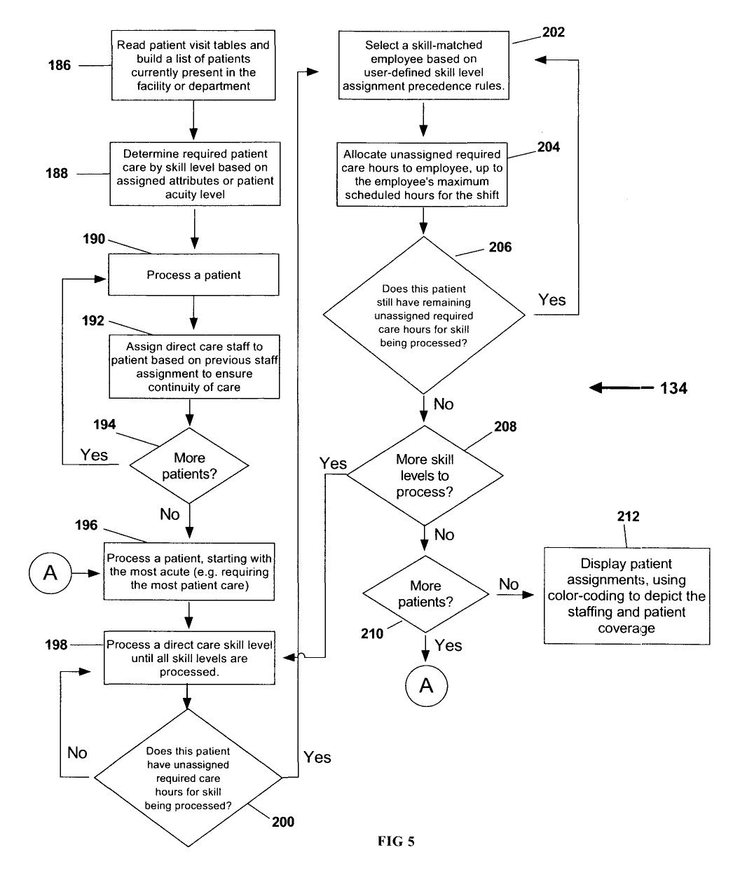

Once all patient care attributes are assigned to a patient, that total patient workload is added to a department workload total (128). If there are more patients to process (130), the classification process (112) is repeated from the step of manually selecting a patient to process (120) until there are no more patients to process. Once patient processing is completed, an initial department workload is calculated and the classification process (112) is completed (132). The next process involves assigning medical staff to patients (134), which process is illustrated in FIG. 5 described below.

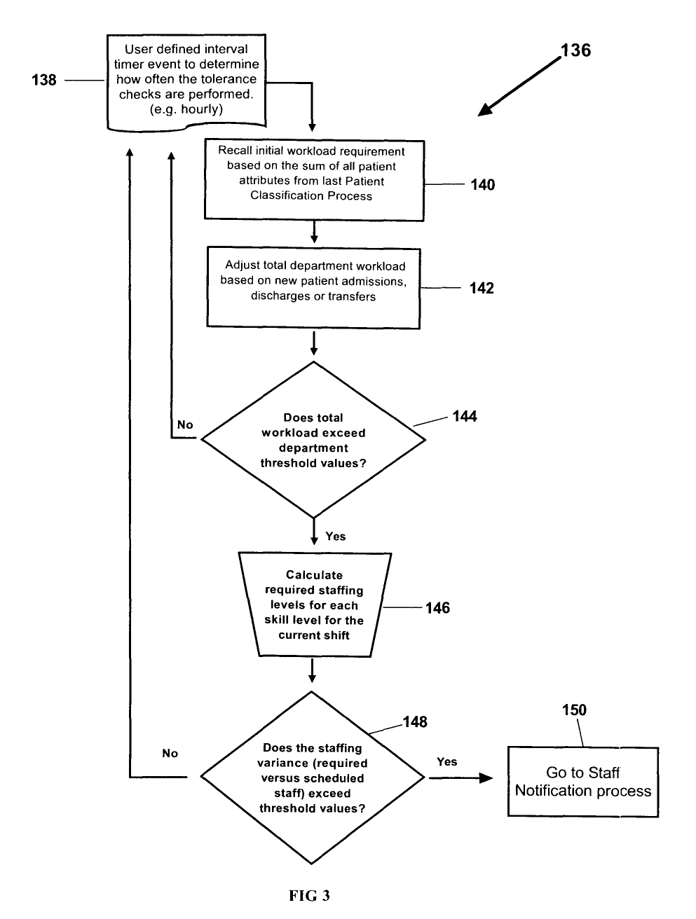

FIG. 3 illustrates a process for checking whether a tolerance level on a patient workload or staffing threshold has been exceeded because of the admission, discharge or transfer of patients or cancellation/scheduling of medical procedures (136). This process is run at user-defined intervals, i.e., hourly (138). These user-defined intervals are set based upon how frequently management desires to check the variance between the patient workload and the scheduled staff. When the process (136) is activated by the interval timer (138) the process recalls the initial workload requirement (140), usually calculated at the start of a shift. As described elsewhere herein, this initial workload requirement is based upon the sum of all patient attribute workload values as determined in the last patient classification process 112. Additionally, when the process (136) is activated, it also looks ahead for a user-defined number of hours and determines or recalls the initial workload requirements for all future shifts within the look ahead period.

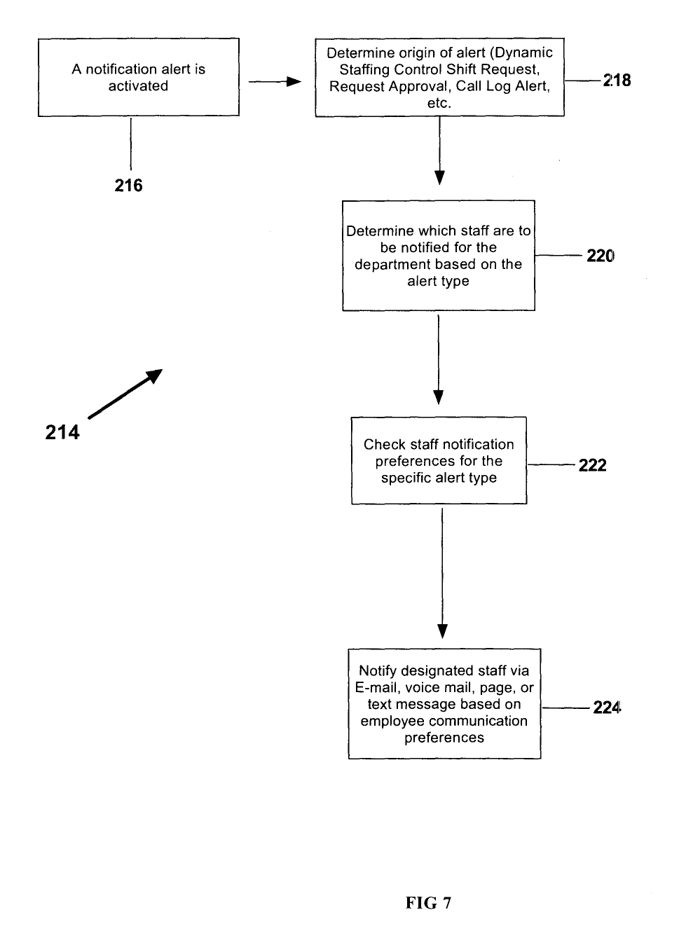

The next step adjusts the total department workload to determine an updated workload requirement based upon new patient admissions, discharges and/or transfers (142). The process then checks if the updated workload requirement varies from the scheduled staff by more than department threshold values (144). The department threshold values are based upon user-defined settings corresponding to an amount of work that the department should be able to handle given current staffing levels. If the updated workload requirement does not exceed these threshold values then the process ends until the next user-defined interval. If the updated workload requirement exceeds the department threshold value, the process next calculates an updated staffing level requirement for each skill level for the current shift (146). The updated staffing level requirements that are calculated are based upon an analysis of the updated workload requirement. The newly calculated updated staffing level requirements are compared to the currently scheduled staff to see if the variance in staffing exceeds user-defined threshold values (148). In this case, the staffing variance can be positive or negative, meaning that either too much or too little staff is scheduled for the updated workload requirement. If the variance threshold value is not exceeded, the process resets to be performed at the next user-defined interval (138). If the staffing variance exceeds threshold values, then the staff notification process (150) illustrated in FIG. 7 will be activated. The process (136) repeats for all future shifts within the look ahead period.

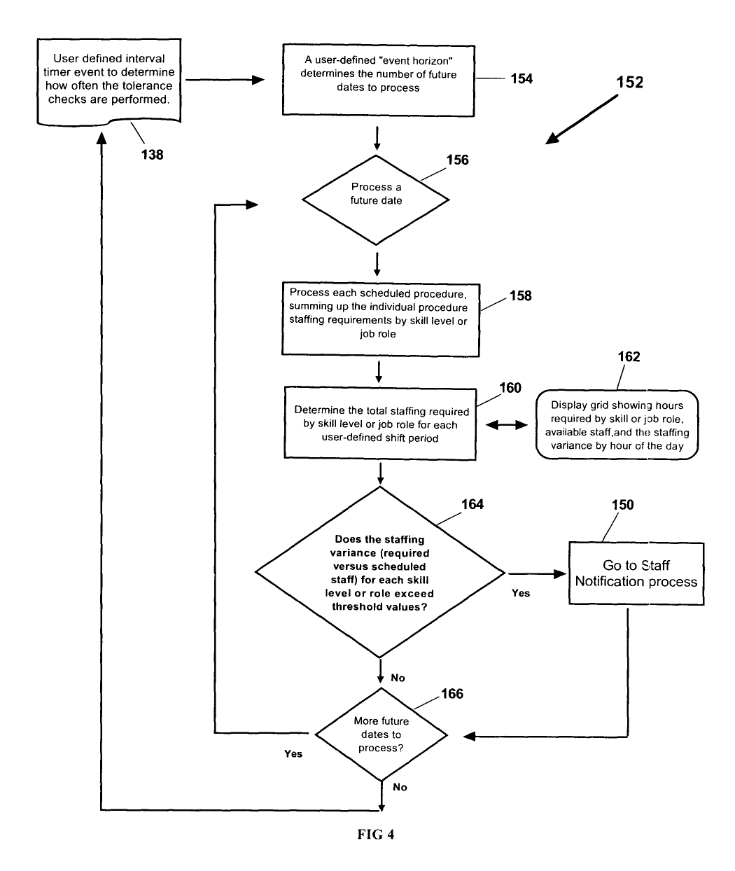

FIG. 4 illustrates the process for performing a surgery workload and staffing variance tolerance check (152). As with the patient workload tolerance check process (136), the surgery workload tolerance check (152) is performed at user-defined intervals (138). This process begins with a determination of the number of future dates to process (154). A user inputs a value corresponding to the number of days in advance for which to perform a surgery workload and staffing variance tolerance check. This user-defined number or “event horizon” will generally be based upon how far in advance a user intends to prepare a work schedule. Once the event horizon is defined, the procedure (152) processes a future date (156). This future date corresponds to one of the days between the present and the event horizon.

The next step involves processing each scheduled procedure on that future date to calculate an initial workload requirement by summing up the individual procedure staffing requirements by skill level or job role (158). (This is in contrast to basing an initial workload requirement on patient care attributes.) Required staffing is determined by reading the surgery schedule for the desired date and using the scheduled surgical case start times and case duration, along with the required staffing levels stored for each procedure profile, to determine the total staff required by role (or skill level) for each time slot. This involves determining the total staffing required by skill level or job role for each user-defined shift period (160). In performing this step, a software subroutine may display a grid showing hours required by skill or job role, available staff, and the staffing variance by hour of the day (162).

A similar process is used to calculate a medical procedure updated workload requirement. First a list of canceled, rescheduled in or out of shift and new medical procedures scheduled since the step of calculating the initial workload requirement is generated. An updated workload requirement for medical procedures takes the initial workload requirement and adds a workload increase and subtracts a workload reduction. The workload increase corresponds to calculation using the scheduled start time along with the duration and required staffing levels stored for each new and rescheduled in shift medical procedure. The workload reduction is calculated based upon a sum of the previously calculated resource workload for each canceled and rescheduled out of shift medical procedure.

Once the total required staff is determined, the procedure determines if the staffing variance (required versus scheduled staff) for each skill level or role exceeds pre-set threshold values (164). If the staffing variance exceeds user-defined threshold values, then the process initiates the staff notification process (150) similar to the patient workload threshold process (136) described above.

Whether the process (152) has initiated the staff notification process or determined that the staffing variance does not exceed the user-defined threshold values, the process then determines whether there are more future dates to process (166). If there are more future dates to process, the routine resumes with the processing of another future date (156), repeating all subsequent steps. When there are no more future dates to process, the routine resets itself until the next user-defined interval (138).

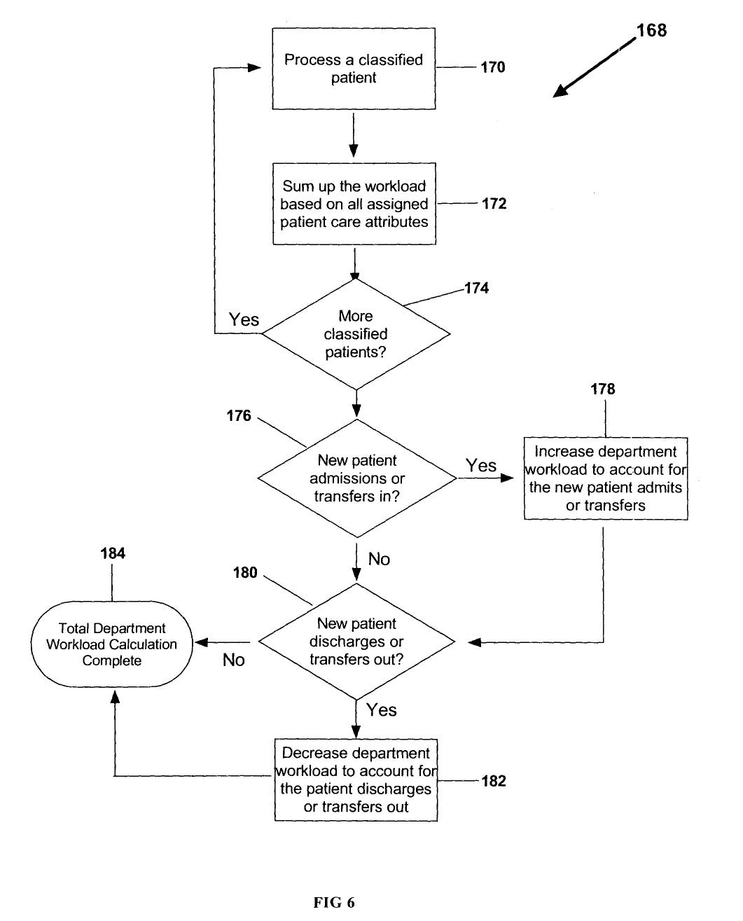

FIG. 6 illustrates a department workload calculation routine (168). This routine begins with the step of processing a patient (170). Processing a patient involves reviewing a patient's medical treatments and assigning patient care attributes to that patient. The next step involves summing up the workload per patient based upon the assigned patient care attributes (172). Each patient care attribute has a workload value assigned to it. The workload values of all assigned attributes are totaled to determine a patient workload for each patient. The process next determines if there are more patients to process (174). If there are more patients, the routine begins with processing the next patient (170).

If there are no more patients to process, the routine next determines if there are new patient admissions or transfers into the department (176). The new patient admissions or transfers in are based upon a reference to the database of patient visit tables (118) generated from patient ADT data as described above. If there are new patient admissions or transfers in, the patient workload for the department is increased to account for the new patient admissions and transfers (178). This increase is determined by multiplying the number of new patient admissions or transfers by a user-defined standard or baseline workload for patients in the department.

Whether or not there are new patients to process, the next step in the routine involves determining whether there are new patient discharges or transfers out of the department (180). If there are new patient discharges or transfers out, then the workload requirement is decreased to account therefor (182). The amount of the decrease is based upon a sum of the previously calculated patient workload value for the discharged or transferred patients. The combined increase and decrease on the initial workload requirement results in the calculation of an updated workload requirement 184.

FIG. 5 illustrates the process for assigning medical staff to care for patients 134. This process begins with the generation of a list of patients for the department (186). Once this list is generated, the process determines the required patient care by skill level based upon assigned attributes or patient acuity level (188). The assigned attributes or patient acuity level are set by a user based upon the patient's medical treatments and were entered during the patient classification process (112) described above.

Next, a patient is processed (190). The processing of a patient involves assigning direct care staff to the patient based upon previous staff assignments to ensure continuity of care (192). Each patient is processed to have previously assigned direct care staff reassigned (194).

Once all patients have been processed for previous staff assignments, patients are next processed starting with the most acute patients (196). In this case, the patients requiring the most care are treated as the most acute. The routine next processes a direct care skill level for the current patient until all skill levels are processed (198). Thus, all skill levels for a particular patient are processed before moving on to the next most acute patient. The routine determines whether the current patient has unassigned required care hours for the skill level being processed (200). If there are not unassigned required care hours for the skill being processed, the routine goes back and processes the next direct care skill level until all skill levels for that patient are processed (198).

If there are unassigned required care hours for the current patient at the current skill level, the routine selects a skill matched medical staff employee based upon user-defined skill level assignment precedence rules (202). These user-defined skill level assignment precedence rules correspond to certain training, experience, and abilities possessed by the various medical staff. The precedence rules are designed to assign staff with training and experience necessary to meet the required care at the given skill level. The routine allocates unassigned required care hours to an employee, up to that employee's maximum scheduled hours for the shift (204). An employee's maximum scheduled hours for the shift may be consumed by the care of one patient. However, more than likely the employee's maximum scheduled hours for the shift will be spread across multiple patients in the facility or department. The routine next determines whether the current patient still has remaining unassigned required care hours for the skill level being processed (206). If there are remaining unassigned required care hours, the routine goes back and selects another skill-matched employee based upon the user-defined skill level assignment precedence rules (202).

If there are no remaining unassigned required care hours for the skill level being processed for the current patient, then the routine determines whether there are more skill levels to process for the current patient (208). If there are more skill levels to process, the routine processes the next direct care skill level for the patient (198). If there are no more skill levels to process, the routine then determines whether there are more patients to process (210). If there are more patients to process, the routine processes the next most acute patient (196), repeating the intervening steps. Once all patients are processed and there are no more unprocessed patients, the routine displays the patient assignments (212). These patient assignments may be displayed using color coding to depict the staffing and patient coverage.

FIG. 7 illustrates the staff notification process (214). In this process, a notification alert is activated (216). A notification alert is activated in the event an updated workload requirement exceeds a threshold value for the staffing variance as described above in FIGS. 3 and 4. Once the notification alert is activated, the origin of the alert is determined (218). The origin of the alert is based upon the cause of the staffing variance exceeding the threshold value. The cause may result from a sudden increase in the number of patients admitted into or medical procedures scheduled for a department. It may also result from a number of discharges without admitted patients replacing those discharged patients. Variances may also result from employee shift requests, request approvals, call log alerts, or similar events.

The routine next determines which staff are to be notified for the department based upon the type of alert (220). Some staff may only want to be notified if the staffing variance results from certain types of events, i.e., emergency situations. The staff to be notified may include administrators, management, and medical staff. If the notified staff may be asked to come in to augment currently scheduled staff, the alert may include an “opt in” or “opt out” choice. This may allow medical staff, i.e., nurses, to notify the system if they are coming in.

Once the appropriate staff to be notified are determined, the routine checks staff notification preferences for those employees for the type of alert (222). These notification preferences are user-defined and correspond to the method of notification most preferred by the particular employee. The notification preferences may include cellular telephone, voicemail, e-mail, text message, automated response, pager, or other means of notifying an individual. Finally, the notification is sent to the designated staff based upon these notification preferences (224).

The above describes each of the various processes and subroutines that may be used in the inventive process. The following material describes how these processes and subroutines interact and cooperate to achieve the inventive process.

The inventive process for dynamic staffing control in a department in a medical care facility begins with calculating an initial workload requirement for the department (112, 158). This initial workload requirement can be calculated in one of two ways. It may be based upon assigned patient care attributes having stated workload requirements which are totaled per patient (112). Alternatively, the initial workload requirement may be calculated based upon a totaling of the staffing requirements by skill level or job role for individually scheduled medical procedures (158). A person having ordinary skill in the art will realize that the selection of a particular process for calculating an initial workload requirement will depend upon the type of department, i.e., ICU would use assigned patient attributes whereas surgery would use scheduled procedures.

Once the initial workload requirement is calculated, the process next determines a staffing level requirement based upon the initial workload requirement (134, 160). Medical staff is next scheduled to meet the staffing level requirement (134, 160). The assignment of medical staff is performed based upon either assigned patient care attributes (134) or required skill levels in job roles for each scheduled medical procedure (160). The variation and method of calculation depends upon the type of department for which staff is being scheduled as described above.

The calculation of the initial workload requirement as well as the determination of staffing level requirements and the assignment of staff is typically performed at or prior to the start of a shift. At some later point in a shift, preferably at user-defined intervals, such as hourly, the process calculates or estimates an updated workload requirement for the department (168). The process also continues for all future shifts within the user-defined look ahead period. In the case of assigned patient care attributes, the updated workload requirement would be based upon the number of patients admitted, discharged and/or transferred to or from the department (168). In the case of patients discharged or transferred from the department, the workload requirement is reduced by that previously calculated patient workload for each patient discharged and/or transferred (180). The initial workload is increased by an amount equal to the number of patients admitted or transferred to the department, multiplied by a pre-determined average patient workload for the department (176). This average or standard patient workload is based upon historically the type of care that patients in the department have required. Where the initial workload requirement was based upon scheduled medical procedures, the updated workload requirement is calculated by reducing the total by an amount equal to the workload for canceled medical procedures and increasing the total by an amount equal to the workload for newly scheduled medical procedures. Newly scheduled medical procedures refers to those scheduled since the last initial workload calculation.

An updated staffing level requirement is then calculated based upon the updated workload requirement. This updated staffing level requirement is calculated in a manner similar to that by which the staffing level requirement was calculated at the start of a shift. This updated staffing level requirement is compared to the scheduled medical staff to determine if the updated requirement varies from the scheduled medical staff by more than a predetermined threshold. If the variance exceeds the predetermined threshold, then management staff is notified of the variance, as described above.

Although several embodiments have been described in some detail for purposes of illustration, various modifications may be made without departing from the scope and spirit of the invention. Accordingly, the invention is not to be limited, except as by the appended claims.

What is claimed is:

1. A process for dynamic staffing control in a medical care facility, comprising the steps of:
calculating an initial workload requirement for the facility;
determining a staffing level requirement based upon the initial workload requirement;
scheduling medical staff in the facility to meet the staffing level requirement;
estimating an updated workload requirement for the facility;
determining an updated staffing level requirement based upon the updated workload requirement;
comparing the updated staffing level requirement to the scheduled medical staff;
sending a notification alert if the difference between the updated staffing level requirement and the scheduled medical staff exceeds a predetermined tolerance.

2. The process of claim 1, wherein the process is applied to a department within the facility.

3. The process of claim 1, wherein the step of calculating the initial workload requirement, comprises the steps of:
generating a list of patients in the facility;
assigning patient care attributes to each patient;
calculating a patient workload for each patient by summing workload values corresponding to the assigned patient care attributes for each patient; and
calculating the initial workload requirement by summing the patient workload for each patient.

4. The process of claim 3, wherein the steps of determining the staffing level requirement and scheduling medical staff, further comprises the steps of:
evaluating required staff hours per patient based upon direct care skill level for assigned patient care attributes and an acuity level for each patient; and
assigning direct care medical staff to each patient based upon patient acuity level, direct care skill levels, prior staff assignments and required staff hours.

5. The process of claim 3, wherein the step of estimating an updated workload requirement, further comprises the steps of:
generating a list of patients discharged or transferred out of the facility and new patients admitted or transferred into the facility since the step of calculating the initial workload requirement;
calculating a workload reduction for the patients discharged or transferred out of the facility;
calculating a workload increase for the new patients admitted or transferred into the facility; and
subtracting the workload reduction from and adding the workload increase to the initial workload requirement for the facility.

6. The process of claim 5, wherein the workload increase is calculated by multiplying the number of new patients admitted and transferred into the facility by a user-defined standard patient workload for the facility and the workload reduction is calculated based upon a sum of the previously calculated patient workload for each patient discharged or transferred out of the facility.

7. The process of claim 1, wherein the step of calculating the initial workload requirement, comprises the steps of:
generating a list of medical procedures to be performed;
assigning resources to each medical procedure;
calculating a resource workload for each medical procedure by using a scheduled start time along with a duration and required staffing level stored for each medical procedure;
calculating the initial workload requirement by summing the resource workload for each medical procedure.

8. The process of claim 7, wherein the steps of determining the staffing level requirement and scheduling medical staff, further comprises the steps of:
determining required staff hours per medical procedure;
summing the required staff hours by skill level or job role in the procedure; and
assigning medical staff for each procedure based upon skill levels or job role.

9. The process of claim 7, wherein the step of estimating an updated workload requirement, further comprises the steps of:
generating a list of canceled, rescheduled in or out of shift and new medical procedures scheduled since the step of calculating the initial workload requirement;
calculating a workload reduction for the canceled and rescheduled out of shift medical procedures;
calculating a workload increase for the rescheduled in shift and new medical procedures; and
subtracting the workload reduction from and adding the workload increase to the initial workload requirement for the facility.

10. The process of claim 9, wherein the workload increase is calculated by using the scheduled start time along with the duration and required staffing level stored for each new and rescheduled in shift medical procedure and the workload reduction is calculated based upon a sum of the previously calculated resource workload for each canceled and rescheduled out of shift medical procedure.

11. The process of claim 1, wherein the step of sending a notification alert, comprises the steps of:
determining a notification cause based upon a reason for the updated staffing level requirement;
determining which staff are to be notified based upon the notification cause;
preparing the notification alert based upon user-defined notification preferences for the notification cause; and
notifying staff by alert means based upon employee communication preferences.

12. The process of claim 1, wherein the process is applied to the current shift and all future shifts that fall within a user-defined scheduling period.

13. A process for dynamic staffing control in a department in a medical care facility, comprising the steps of:
generating a list of patients in the department;
assigning patient care attributes to each patient;
calculating a patient workload for each patient by summing workload values corresponding to the assigned patient care attributes for each patient;
calculating an initial workload requirement by summing the patient workload for each patient;
determining a staffing level requirement based upon the initial workload requirement by evaluating required staff hours per patient based upon direct care skill level for assigned patient care attributes and an acuity level for each patient;
scheduling medical staff in the facility by assigning direct care medical staff to each patient in the department based upon patient acuity level, direct care skill levels, prior staff assignments and required staff hours to meet the staffing level requirement;
generating a list of patients discharged or transferred out of the department and new patients admitted or transferred into the department since the step of calculating the initial workload requirement;
calculating a workload reduction for the patients discharged or transferred out of the department;
calculating a workload increase for the new patients admitted or transferred into the department;
estimating an updated workload requirement by subtracting the workload reduction from and adding the workload increase to the initial workload requirement;
determining an updated staffing level requirement based upon the updated workload requirement;
comparing the updated staffing level requirement to the scheduled medical staff;
sending a notification alert if the difference between the updated staffing level requirement and the scheduled medical staff exceeds a predetermined tolerance.

14. The process of claim 13, wherein the workload increase is calculated by multiplying the number of new patients admitted and transferred into the department by a user-defined standard patient workload for the department and the workload reduction is calculated based upon a sum of the previously calculated patient workload for each patient discharged or transferred out of the department.

15. The process of claim 13, wherein the step of sending a notification alert, comprises the steps of:
determining a notification cause based upon a reason for the updated staffing level requirement;
determining which staff are to be notified based upon the notification cause;
preparing the notification alert based upon user-defined notification preferences for the notification cause; and
notifying staff by alert means based upon employee communication preferences.

16. A process for dynamic staffing control in a department in a medical care facility, comprising the steps of:
generating a list of medical procedures to be performed in the department;
assigning resources to each medical procedure;
calculating a resource workload for each medical procedure by using a scheduled start time along with a duration and required staffing level stored for each medical procedure;
calculating an initial workload requirement by summing the resource workload for each medical procedure;
determining a staffing level requirement based upon the initial workload requirement by evaluating required staff hours per medical procedure;
summing the required staff hours by skill level or job role in the procedure;
scheduling medical staff in the department by assigning medical staff for each procedure based upon skill levels or job role to meet the staffing level requirement;
generating a list of canceled, rescheduled in or out of shift and new medical procedures scheduled since the step of calculating the initial workload requirement;
calculating a workload reduction for the canceled and rescheduled out of shift medical procedures;
calculating a workload increase for the rescheduled in shift and new medical procedures; and
estimating an updated workload requirement for the department by subtracting the workload reduction from and adding the workload increase to the initial workload requirement for the department;
determining an updated staffing level requirement based upon the updated workload requirement;
comparing the updated staffing level requirement to the scheduled medical staff;
sending a notification alert if the difference between the updated staffing level requirement and the scheduled medical staff exceeds a predetermined tolerance.

17. The process of claim 16, wherein the workload increase is calculated by using the scheduled start time along with the duration and required staffing level stored for each new and rescheduled in shift medical procedure and the workload reduction is calculated based upon a sum of the previously calculated resource workload for each canceled or rescheduled out of shift medical procedure.

18. The process of claim 16, wherein the step of sending a notification alert, comprises the steps of:
determining a notification cause based upon a reason for the updated staffing level requirement;
determining which staff are to be notified based upon the notification cause;
preparing the notification alert based upon user-defined notification preferences for the notification cause; and
notifying staff by alert means based upon employee communication preferences.

19. A process for dynamic staffing control in a department in a medical care facility, comprising the steps of:
calculating an initial workload requirement for the department;
determining a staffing level requirement based upon the initial workload requirement;
scheduling medical staff in the department to meet the staffing level requirement;
estimating an updated workload requirement for the department;
determining an updated staffing level requirement based upon the updated workload requirement;
comparing the updated staffing level requirement to the scheduled medical staff;
sending a notification alert if the difference between the updated staffing level requirement and the scheduled medical staff exceeds a predetermined tolerance wherein this sending step comprises the steps of:
determining a notification cause based upon a reason for the updated staffing level requirement;
determining which staff are to be notified based upon the notification cause, preparing a notification alert based upon user-defined notification preferences for the notification cause, and sending the notification alert to the staff to be notified.

20. The process of claim 19, wherein the step of calculating the initial workload requirement, comprises the steps of:
generating a list of patients in the department;
assigning patient care attributes to each patient;
calculating a patient workload for each patient by summing workload values corresponding to the assigned patient care attributes for each patient; and
calculating the initial workload requirement by summing the patient workload for each patient.

21. The process of claim 20, wherein the steps of determining the staffing level requirement and scheduling medical staff, further comprises the steps of:
evaluating required staff hours per patient based upon direct care skill level for assigned patient care attributes and an acuity level for each patient; and
assigning direct care medical staff to each patient based upon patient acuity level, direct care skill levels, prior staff assignments and required staff hours.

22. The process of claim 20, wherein the step of estimating an updated workload requirement, further comprises the steps of:
generating a list of patients discharged or transferred out of the department and new patients admitted or transferred into the department since the step of calculating the initial workload requirement;
calculating a workload reduction for the patients discharged or transferred out of the department based upon a sum of the previously calculated patient workload for each patient discharged or transferred out of the department;
calculating a workload increase for the new patients admitted or transferred into the department by multiplying the number of new patients admitted and transferred into the department by a user-defined standard patient workload for the department and the workload reduction is calculated; and
subtracting the workload reduction from and adding the workload increase to the initial workload requirement for the department.

23. The process of claim 19, wherein the step of calculating the initial workload requirement, comprises the steps of:
generating a list of medical procedures to be performed;
assigning resources to each medical procedure;
calculating a resource workload for each medical procedure by using a scheduled start time along with a duration and required staffing level stored for each medical procedure;
calculating the initial workload requirement by summing the resource workload for each medical procedure.

24. The process of claim 23, wherein the steps of determining the staffing level requirement and scheduling medical staff, further comprises the steps of:
determining required staff hours per medical procedure;
summing the required staff hours by skill level or job role in the procedure; and
assigning medical staff for each procedure based upon skill levels or job role.

25. The process of claim 23, wherein the step of estimating an updated workload requirement, further comprises the steps of:
generating a list of canceled, rescheduled in or out of shift and new medical procedures scheduled since the step of calculating the initial workload requirement;
calculating a workload reduction for the canceled and rescheduled out of shift medical procedures based upon a sum of the previously calculated resource workload for each canceled and rescheduled out of shift medical procedure;
calculating a workload increase for the new and rescheduled in shift medical procedures by using the scheduled start time along with the duration and required staffing level stored for each new and rescheduled in shift medical procedure; and
subtracting the workload reduction from and adding the workload increase to the initial workload requirement for the department.
